(19) United States
(12) Patent Application Publication
(10) Pub. No.: US 2005/0225251 A1
(43) Pub. Date: Oct. 13, 2005

(54) Active matrix OLED pixel structure and a driving method thereof

(75) Inventor: Wei-Chieh Hsueh, Tainan (TW)

Correspondence Address: WILDMAN HARROLD ALLEN & DIXON, 225 WEST WACKER DRIVE, SUITE 2800, CHICAGO, IL, 60606, US

(73) Assignee: Toppoly Optoelectronics Corp.

(21) Appl. No.: 10/998,404

(22) Filed: Nov. 29, 2004

(30) Foreign Application Priority Data
Apr. 9, 2004 (TW) 93110020

(51) Int. Cl. G09G 3/10

(52) U.S. Cl. 315/169.2; 315/169.3

(57) ABSTRACT

A pixel structure and its driving method, which are used in the active matrix organic illuminated displays, are described. The pixel structure has four transistors, a capacitor and three signal lines. The first and second transistors are used as the switching transistors and controlled by the first and second scan lines, respectively. The third and fourth transistors together constitute a current mirror to equalize the current flows through the OLED in each pixel and the writing in current in the data line. Therefore, the illumination of the OLED between each pixel will be more uniform and is not influenced by the threshold voltage.

### RELATED APPLICATIONS

The present application is based on, and claims priority from, Taiwan Application Serial Number 93110020, filed on Apr. 9, 2004, the disclosure of which is hereby incorporated by reference herein in its entirety.

### BACKGROUND

1. Field of Invention

The present invention relates to a pixel structure and a driving method of an Active Matrix Organic Light Emitting Diode (AMOLED) display. More particularly, the present invention relates to a pixel structure, which is able to compensate for the influence of the variation of the threshold voltage and electron mobility, and the operation method thereof.

2. Description of Related Art

A Light Emitting Diode (LED) display is a kind of matrix display; as FIG. 1 shows, the LEDs are ranked in columns and rows, and the anodes or cathodes in each column or each row are all connected together. Referring to FIG. 1, display 10 typically comprises the display units, i.e. pixels 20, in the columns and the rows, and the anode and the cathode of each pixel are respectively coupled with column data generator 12 and row selection generator 14. Row line 16 activates every row in order, and the column line 18 activates the corresponding pixel during the operation process. According to the driving method, the luminous display technologies can be distinguished into passive and active at present. It can be seen that the requirements for displays will increase in the future, according to the needs for high resolution and large area, and the active organic light emitting display technologies will undoubtedly become a mainstream technology in the market.

In addition, Organic Light Emitting Diode (OLED) displays are thought to be one of the flat-panel display technologies having the most potential to replace the Liquid Crystal Display (LCD) in the twenty-one century because an OLED is self-illuminating, suffers no viewing angle restriction, has a short response time, is highly photoelectrically efficient and power conservative, and needs neither a back light nor color lens. FIG. 2 illustrates a pixel structure of the general active driving OLED display. Referring to FIG. 2, the pixel structure 100 comprises a switching Thin-Film Transistor (TFT) 102, a driving TFT 104, a storage capacitor 106 and an OLED device 108. The function of the switching TFT 102 is to provide a switch and an address when the image data are loaded into the storage capacitor 106. The function of the driving TFT 104 is to transform the voltage of capacitor 106 into current. Finally, the OLED device 108 is driven. For example, after the switching TFT 102 is switched by a signal from a gate line 112, a data line 110 outputs a signal to charge and discharge the storage capacitor 106. Then the status of the driving TFT 104 determines whether the OLED device 108 is ON or OFF.

The luminous intensity of the OLED device 108 is determined by and has a direct proportion to the current flow through the OLED device 108. Nevertheless, even if the storage capacitors 106 in each pixel structure all have an identical voltage, the current flow through the OLED device 108 is still different and results in irregular illumination in the OLED device 108 due to the difference in the threshold voltage of the driving TFT 104 between the pixels from the fabrication process.

### SUMMARY

According to the foregoing background of the invention, an organic illuminated display device often suffers from irregular illumination because of the influence of currents. It is therefore an objective of the present invention to provide a pixel structure, which comprises four transistors, a storage capacitor and three signal lines. The pixel structure uses a current mirror to transform the current into the voltage and then transform the voltage back into current. The current flow through the organic illuminated display devices will thus not be significantly influenced by variations of the threshold voltage and the electron mobility of the transistors.

According to the objective of the present invention, the pixel structure of the active matrix organic illumination device comprises a capacitor, a illumination device, a data line, a plurality of scan lines including a first scan line and a second scan line, and a plurality of transistors including a first transistor, a second transistor, a third transistor and a fourth transistor. The gate and either of the source and the drain of the first transistor are coupled to a terminal of the first scan line, and the other terminal of the first scan line is coupled to the third transistor. The gate of the second transistor is coupled to the second scan line, either of the source and drain of the second transistor is coupled to the third transistor, and the other is coupled to the capacitor and the fourth transistor. The gate of the third transistor is coupled to the second transistor, and the drain of the third transistor is coupled to the first transistor and the source of the third transistor. The gate of the fourth transistor is coupled to the second transistor and the capacitor, and the drain of the fourth transistor is coupled to the illumination device.

In the pixel structure of the present invention, both the third and the fourth transistor are P-type transistors, and both the first and the second transistor are not restricted to P-type or N-type transistor. The pixel structure can compensate for the influence of the variation in the threshold voltage and electron mobility in the illuminated display device to provide uniform illumination by the pixel structure of the present invention.

In the embodiment of the present invention, the first scan line and the second scan line may be coupled with each other or alone by selection. Illumination compensation is provided by varying the length of light radiating in accordance with the illumination efficiency of the OLED when both the first and the second scan line are coupled alone.

In according to the objective of the present invention, the invention is provided for a display system that at least has a display controller and a display. The display controller is coupled to the display.

The display controller provides at least a data line signal and two scan line signals. The display receives at least a data line signal and two scan line signals from the display controller for controlling the states of displaying.

The display comprises a plurality of pixels that is the pixel structure of the foregoing active matrix organic illumination device, where the third and the fourth transistor form a current mirror structure for providing a driving current for the illumination device.

The foregoing pixel structure and principle may be generalized as a method for providing a driving current for an LED such as, for example, an OLED. The method comprises the following steps. First, a pixel driving circuit is made with a current mirror circuit and a capacitor. Then a first scan line, a second scan line and a data line are coupled to the pixel driving circuit. Next, three modes such as clear mode, write-in mode and illumination mode are provided in the pixel driving circuit by the first and second scan line.

### BRIEF DESCRIPTION OF THE DRAWINGS

The invention can be more fully understood by reading the following detailed description of the preferred embodiment, with reference made to the accompanying drawings as follows:

FIG. 1 is a partial block diagram of a matrix display;

FIG. 2 is a schematic of a typical pixel structure of an active organic illuminated display in the prior art;

FIG. 3A is a block diagram of a general display system;

FIG. 3B is a schematic of a single pixel structure of a active driving organic illuminated display according to the present invention;

FIG. 4 is an equivalent circuit schematic of FIG. 3B when both switching TFTs are ON in the data writing step;

FIG. 5 is a clock pulse schematic revealing a pixel structure signal control according to the present invention; and

FIG. 6 is a flow chart showing a method to control driving current according to an embodiment of the present invention.

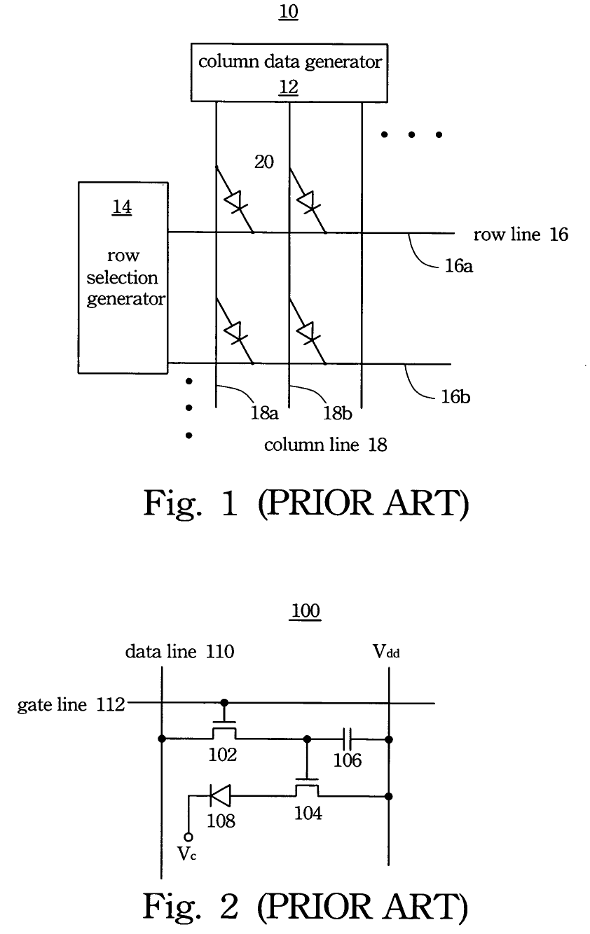

### DESCRIPTION OF THE PREFERRED EMBODIMENTS

Reference will now be made in detail to preferred embodiments of the present invention, examples of which are illustrated in the accompanying drawings. Wherever possible, the same reference numbers are used in the drawings and the description to refer to the same or like parts.

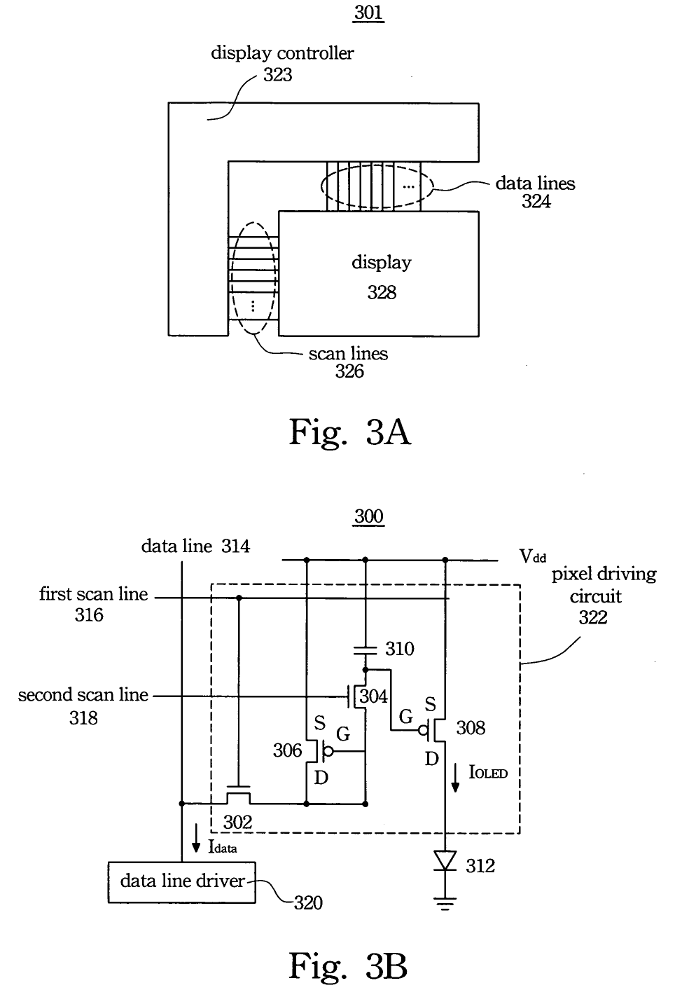

FIG. 3A shows a whole display system 301 according to a preferred embodiment of the present invention. The whole display system 301 is divided into two parts comprising a display controller 323 and a display area 328. The display controller 323 is coupled to the display area 328.

The display controller 323 provides a plurality of data lines 324 and a plurality of scan lines 326 so that the display area 328 receives at least one data line signal and at least one scan line signal to control the states of display.

In this embodiment, the display area 328 comprises a plurality of pixel structure 300. The pixel structure 300 is an active matrix organic illumination device pixel structure. FIG. 3B is a schematic of a single pixel structure of the active matrix organic illumination device pixel structure. TFT and OLED devices are utilized as the pixel structure in this embodiment. The present invention can be applied in any display device having another kind of transistor and OLED as known by persons skilled in the art to improve the irregular illumination, and is not to be restricted by this embodiment.

Referring to FIG. 3B, the pixel structure 300 of the present invention comprises a pixel driving circuit 322. The pixel driving circuit 322 is separately coupled to a first scan line 316, a second scan line 318, a data line 314 and an OLED 312. Referring to FIG. 3A and FIG. 3B, the first scan line 316 and the second scan line 318 are a part of scan lines 326, and data line 314 is a part of data lines 324.

The Pixel driving circuit 322 mirrors current I_{data} in the data line 314 into current I_{OLED} in accordance with the voltage of the first scan line 316 and the second scan line 318. The OLED 312 is driven to illuminate by Current I_{OLED}.

The Pixel driving circuit 322 has a current mirror structure, which can mirror current I_{data} into current I_{OLED}.The following embodiment is an example of the current mirror. Any of the current mirror structures having a generally similar function may be used in the pixel driving circuit, with some modifications, within the spirit and scope of the present invention.

Referring to FIG. 3B, the pixel structure 300 comprises a transistor 302, a transistor 304, a transistor 306, a transistor 308, a storage capacitor 310, an OLED 312, a data line 314, a first scan line 316 and a second scan line 318. The transistor 302 is a switching transistor, and may be a P-type or N-type transistor controlled by the first scan line 316. One terminal thereof is coupled to the data line 314 and the other terminal thereof is coupled to the transistor 304 and the transistor 306. The transistor 304 is also a switching transistor, and may be a P-type or N-type transistor controlled by the second scan line 318. One terminal thereof is coupled to capacitor 310 and the transistor 308 and the other terminal thereof is coupled to the transistor 306 and the transistor 302. The transistor 306 is a P-type transistor in the embodiment of the present invention; the gate thereof is coupled to transistor 304 and capacitor 310, the drain thereof is coupled to transistor 302, and the source thereof is coupled to voltage V_{dd}. In addition, a terminal of the capacitor 310, which is coupled to the transistor 304 and the transistor 308, and another terminal is coupled to voltage Vdd.

the transistor 302 and the transistor 304 are controlled by the first scan line 316 and the second scan line 318 respectively during the operation process. The data write-in mode is enabled while the voltage of both the first scan line 316 and the second scan line 318 are high, and the transistor 302 and the 304 are turned on. Thus, the data line driver 320 will draw out a constant current I_{data} from the data line 314, and the transistor 306 will generate a current flow toward the data line driver 320. At this time, only the first scan line 316 and the second scan line 318 of the pixel structure 300 are driven to turn on the transistor 302 and the transistor 304 rather than the other pixel structures coupled to the data line 314, although the data line 314 is coupled to many pixels. Therefore, the data line 314 may be seen as floating, and the current flowing through the transistor 306 is equal to the magnitude of I_{data}.

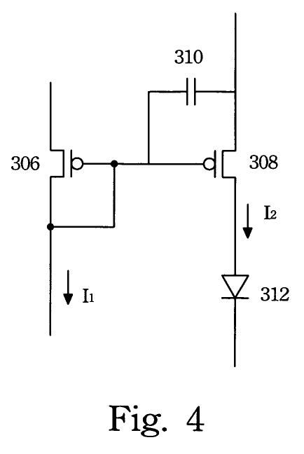

When the ratio of width to length (W/L) of the transistor 306 and the transistor 308 match threshold voltage Vth, it equals the magnitude of I_{data} and the current flowing through the transistor 308 because the transistor 306 and the transistor 308 may be seen as a current mirror structure. FIG. 4 shows an equivalent circuit thereof. Referring to FIG. 4, the output current I₂ of the transistor 308 is equal to current I₁ while the transistor 306 draws out current I₁ in the current mirror structure.

The pixel structure 300 is in the illumination mode, and the OLED 312 is illuminated when the voltage of the first scan line 316 is high and the voltage of the second scan line 318 is low. The pixel structure 300 is in the data clear mode, and the capacitor 310 is in the data clear state when the voltage of the first scan line 316 is low and the voltage of the second scan line 318 is high. Both transistor 302 and transistor 304 are in the OFF state when both the voltage of the first scan line 316 and the second scan line 318 are low; at this time, the capacitor 310 stores a voltage value generated by the transformation from I_{data} value of the transistor 306. Then the transistor 308 transforms the voltage of the capacitor 310 into a current for driving the OLED 312. Due to the current mirror, the transistor 308 will transform and output a steady current, although the capacitor 310 of each pixel may store different voltage values caused by the different voltage and threshold voltage. Therefore, the current I_{OLED} flowing through the OLED 312 is always identical to the writing current I_{data} in the data line, whether the voltage or threshold voltage of the capacitor 310 of each pixel is different. For example, each pixel structure is written in by a current with magnitude value X, but the capacitor of each pixel structure stores a voltage value with magnitude value Y1, Y2 and Y3, respectively; however the magnitude value of all the current flow through every OLED will still be X. Consequently, the whole display panel is illuminated with uniform intensity.

The difference between the prior art and present invention is that the gray level is determined by driving voltage in the pixel structure of the prior art, and it is determined by driving current in the present invention. Furthermore, the current mirror structure of the present invention keeps the current flowing through the OLED identical to the writing current of the data line in each pixel; therefore, the illumination intensity is not influenced by the difference of the threshold voltage and electron mobility between each pixel.

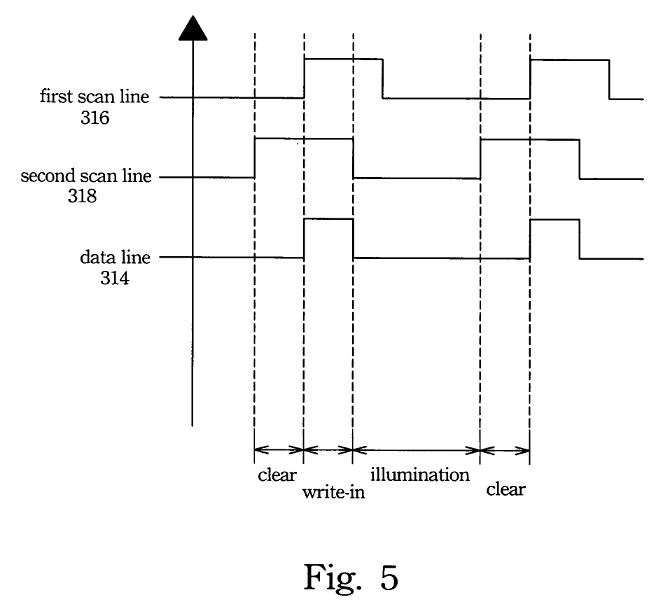

FIG. 5 shows a clock pulse diagram of the pixel structure signal control according to the present invention. Referring to FIG. 5, the second scan line 318 is enabled earlier than the first scan line 316 in the pixel structure of the present invention; e.g. the transistor 304 is turned on earlier than the transistor 302 in FIG. 3, in the data clear step. Referring to FIG. 3, the current flows toward the transistor 304 and the capacitor 310 from the transistor 306 for clearing the data in the capacitor 310 when the states of the transistor 302 and the transistor 304 are OFF and ON, respectively.

Referring to FIG. 5 and FIG. 3B, data are written in when both the first and second scan line are in high voltage; e.g., both transistor 302 and transistor 304 are ON. Hence, the data line driver 320 will draw out a constant current I_{data} from the data line 314, and the transistor 306 will generate a current as well. Because the transistor 306 and the transistor 308 can be seen as a current mirror structure, the magnitude of current I_{OLED} flowing through the transistor 308 is identical to the magnitude of current I_{data} when the ratio W/L and threshold voltage of the transistor 306 and the transistor 308 match. Current I_{OLED} is able to drive the OLED 312 to illuminate.

Referring to FIG. 5 and FIG. 3B, the transistor 308 transforms the voltage, which was transformed from the current I_{data} flowing through the transistor 306, in the capacitor 310 into a current for driving the OLED 312 when both first scan line 316 and second scan line 318 are in low voltage; e.g. both transistor 302 and transistor 304 are OFF.

Referring to FIG. 5, repeating the foregoing steps of clear, write-in and illumination are the sequence in time of the operation circuit in practice.

The pixel structure according to the present invention includes a current mirror. Therefore, the current respectively flowing through the OLEDs is not influenced by the difference in the voltage and threshold voltage of the capacitors or transistors, and every OLED is illuminated with uniform intensity.

The foregoing first and second scan lines may be coupled to each other, but coupling the first and second scan lines alone, respectively, will further have the function of reducing the difference in illumination efficiency of the red (R), green (G) and blue (B) OLEDs.

For example, it is assumed that the red OLED has the worst illumination efficiency and the green OLED has the best within the red, green and blue OLEDs. Then the different illumination driving time can be utilized to compensate for this problem to make all the red, green and blue OLEDs have a uniform illumination intensity in a time frame by reducing the illumination time of the second scan line in the green OLED pixel structures or increasing the illumination time of the second scan line in the red OLED pixel structures between the data write-in and data clear steps.

The foregoing pixel structure and its principle can be generalized as a method for providing a driving current of the LED, such as OLED.

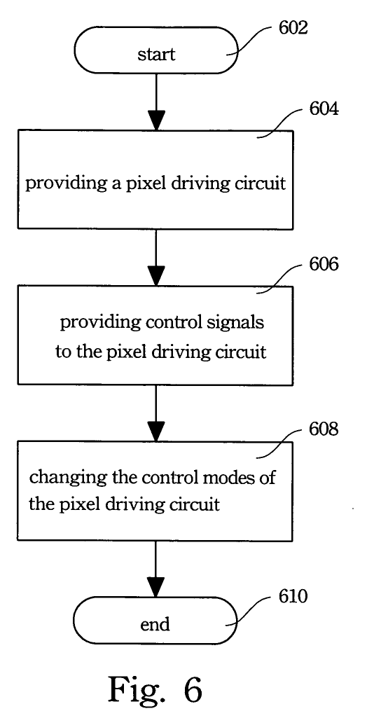

FIG. 6 shows a flow chart of the method. The method at least includes the following steps. First, a pixel driving circuit is provided by a current mirror circuit and a capacitor (step 604), as described above.

Next, a first scan line, a second scan line and a data line are coupled to the pixel driving circuit (step 606), as described in the embodiment.

Then, the clear, write-in and illumination mode are provided in the pixel driving circuit by the first and second scan line (step 608).

Referring to FIG. 3B, FIG. 5 and FIG. 6, the pixel structure is in the data clear mode when the first scan line is in low voltage and the second scan line is in high voltage. At this time, the capacitor is in the data clear state.

The pixel structure is in the write-in mode when both the first and the second scan line are in high voltage. At this time, current I_{data} in the data line is mirrored into a driving current of the LED.

The pixel structure is in the illumination mode when the first scan line is in high voltage and the second scan line is in low voltage. At this time, the LED is in the illumination state.

An advantage of the foregoing method is that the length of the clear mode, write-in mode and illumination mode can be selectively adjusted according to the practical requirements. Thus, the problem of non-uniform luminosity caused by the different illumination efficiency between three-chromatic lights, such as red, green and blue, can be compensated for.

Another advantage of the foregoing method is that the instability of the driving current caused by the different conditions in the fabrication process can be avoided by mirroring a steady current to drive the LED.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A pixel structure of an active matrix driving LED, comprising:
a capacitor;
an illumination device;
a plurality of signal lines, comprising a data line, a first scan line and a second scan line;
a plurality of transistors, comprising a first transistor, a second transistor, a third transistor and a fourth transistor; wherein
a gate of said first transistor is coupled to said first scan line, and a source of said first transistor is coupled to said data line and a drain of said first transistor is coupled to said third transistor, or said drain of said first transistor is coupled to said data line and said source of said first transistor is coupled to said third transistor;
a gate of said second transistor is coupled to said second scan line, and a source of said second transistor is coupled to said third transistor and a drain of said second transistor is coupled to said capacitor and said fourth transistor, or said drain of said second transistor is coupled to said third transistor and said source of said second transistor is coupled to said capacitor and said fourth transistor,
a gate of said third transistor is coupled to said second transistor, a drain of said third transistor is coupled to said first transistor and said gate and said drain of said third transistor are coupled with each other; and
a gate of said fourth transistor is coupled to said second transistor and said capacitor, and a drain of said fourth transistor is coupled to said illumination device.

2. The pixel structure according to claim 1, wherein said third transistor and said fourth transistor are P-type transistors.

3. The pixel structure according to claim 1, wherein said illumination device is an organic light emitting diode (OLED).

4. The pixel structure according to claim 1, wherein said first scan line and said second can line are coupled with each other.

5. The pixel structure according to claim 1, wherein said first scan line and said second scan line are not coupled with each other.

6. An illumination device driving circuit, comprising:
a capacitor; and
a plurality of transistors, comprising a first transistor, a second transistor, a third transistor and a fourth transistor; wherein
a gate of said first transistor is coupled to a first scan line, and a source of said first transistor is coupled to a data line and a drain of said first transistor is coupled to said third transistor, or said drain of said first transistor is coupled to said data line and said source of said first transistor is coupled to said third transistor;
a gate of said second transistor is coupled to a second scan line, a source of said second transistor is coupled to said third transistor and a drain of said second transistor is coupled to said capacitor and said fourth transistor, or said drain of said second transistor is coupled to said third transistor and said source of said second transistor is coupled to said capacitor and said fourth transistor;
a gate of said third transistor is coupled to said second transistor, a drain of said third transistor is coupled to said first transistor and said gate and said drain of said third transistor are coupled with each other; and
a gate of said fourth transistor is coupled to said second transistor and said capacitor, and a drain of said fourth transistor is coupled to an illumination device.

7. The illumination device driving circuit according to claim 6, wherein said third transistor and said fourth transistor are P-type transistors.

8. A driving method of the illumination device-driving circuit as in claim 6, comprising the steps of:
providing a first voltage in said second scan line for turning on said second transistor; and
providing a second voltage in said first scan line for turning on said first transistor; wherein
said second voltage is provided after said first voltage.

9. A display system, comprising:
a display controller with a plurality of data line signals and a plurality of scan line signals;
a plurality of light emitting diodes (LED), wherein each of said LEDs receives a driving current to illuminate; and
a plurality of current mirror circuits corresponding to said LEDs, wherein each of said current mirror circuits is separately coupled to said display controller and each of said LEDs, correspondingly, said current mirror circuits receive a corresponding data line signal from said data line signals and a plurality of scan line signals from said scan line signals; wherein
each of said current mirror circuits mirrors a current in each of said data line signals respectively into said driving current of each of said LEDs, respectively, for driving each of said LEDs, and three modes, including a clear mode, a write-in mode and an illumination mode, of each of said current mirror circuits are determined by a plurality of corresponding scan signals of said scan lines.

10. The display system according to claim 9, further comprising a step of receiving two corresponding scan line signals of said scan line signals in each of said LEDs at different times.

11. The display system according to claim 9, wherein each of said current mirror circuit comprises:
a capacitor; and
a plurality of transistors, comprising a first transistor, a second transistor, third transistor and a fourth transistor; wherein
a gate of said first transistor is coupled to a first scan line, and a source of said first transistor is coupled to a data line and a drain of said first transistor is coupled to said third transistor, or said drain of said first transistor is coupled to said data line and said source of said first transistor is coupled to said third transistor;
a gate of said second transistor is coupled to a second scan line, and a source of said second transistor is coupled to said third transistor and a drain of said second transistor is coupled to said capacitor and said fourth transistor, or said drain of said second transistor is coupled to said third transistor and said source of said second transistor is coupled to said capacitor and said fourth transistor;
a gate of said third transistor is coupled to said second transistor, a drain of said third transistor is coupled to said first transistor and said gate and said drain of said third transistor are coupled with each other; and
a gate of said fourth transistor is coupled to said second transistor and said capacitor, and a drain of said fourth transistor is coupled to said LED correspondingly.

12. A method for providing a driving current of an LED, comprising the steps of:
coupling a first scan line, a second scan line, a data line and an LED to a current mirror circuit;
mirroring a current in the data line into said driving current of said LED by the current mirror circuit; and
providing a clear mode, a write-in mode and a illumination mode in said current mirror circuit by controlling said first scan line and said second scan line.

13. A method for providing a driving current of an LED according to claim 12, wherein the LED is an OLED.

14. A method for providing a driving current of an LED according to claim 12, comprising the steps of:
providing a first voltage of said second scan line; and
providing a second voltage of said first scan line; wherein
said second voltage is provided after said first voltage.
